(19) United States
(12) Patent Application Publication
(10) Pub. No.: US 2014/0003275 A1
(43) Pub. Date: Jan. 2, 2014

(54) RADIO COMMUNICATION SYSTEM AND COMMUNICATION CONTROL METHOD

(71) Applicants: Akihito Morimoto, Chiyoda-ku (JP); Nobuhiko Miki, Chiyoda-ku (JP); Masashige Shirakabe, Chiyoda-ku (JP)

(72) Inventors: Akihito Morimoto, Chiyoda-ku (JP); Nobuhiko Miki, Chiyoda-ku (JP); Masashige Shirakabe, Chiyoda-ku (JP)

(73) Assignee: NTT DOCOMO, INC., Tokyo (JP)

(21) Appl. No.: 14/005,685

(22) PCT Filed: Jul. 18, 2012
(86) PCT No.: PCT/JP2012/068184

§ 371 Date: Sep. 17, 2013

(30) Foreign Application Priority Data
Aug. 1, 2011 (JP) 2011-168190

(51) Int. Cl. H04L 5/00; H04W 24/10

(52) U.S. Cl. CPC H04L 5/0073; H04W 24/10
USPC 370/252

(57) ABSTRACT

In a radio communication system provided with first radio base stations, second radio base stations, and a mobile station, the first radio base stations execute transmission of radio signals to the mobile station, located in first cells, in a first period, and stop the transmission of the radio signals to the mobile station in a second period; and the second radio base stations execute transmission of radio signals to the mobile station, located in second cells, in both the first period and the second period. In the first period, first radio base stations and second radio base stations included in a coordinated-transmission base station set are capable of coordinating with each other to send radio signals, whereas, in the second period, the second radio base stations included in the coordinated-transmission base station set are capable of coordinating with each other to send radio signals.

### TECHNICAL FIELD

The present invention relates to radio communication systems and communication control methods.

### BACKGROUND ART

In these years, various interference control technologies have been proposed in radio communication systems such as cellular telephone networks. For example, Non-Patent Document 1 has proposed inter-cell interference coordination (ICIC), which reduces interference between radio signals (radio waves) sent from radio base stations by using different radio resources (time, frequency, or the like) between the radio base stations. In addition, Non-Patent Document 2 has proposed coordinated multiple point transmission and reception (CoMP), which reduces interference between radio signals sent from a plurality of radio base stations by making the radio base stations send the radio signals in coordination with each other.

On the other hand, in order to use radio resources efficiently, heterogeneous networks (HetNets) have been proposed, in which a plurality of types of radio base stations having different transmission powers (transmission capabilities), such as a macro base station, a pico base station, a femto base station, and a remote radio head, are installed in a multi-layered manner (see Non-Patent Document 3).

### CITATION LIST

### Non-Patent Documents

Non-Patent Document 1: Arne Simonsson, “Frequency Reuse and Intercell Interference Coordination in E-UTRA”, Vehicular VTC2007-Spring, pp. 3091-3095 (April 2007)

Non-Patent Document 2: 3rd Generation Partnership Project; Technical Specification Group Radio Access Network; Evolved Universal Terrestrial Radio Access (E-UTRA); Further advancements for E-UTRA physical layer aspects (Release 9); 3GPP TR 36.814 V9.0.0 (March 2010); Section 8, Coordinated multiple point transmission and reception

Non-Patent Document 3: 3rd Generation Partnership Project; Technical Specification Group Radio Access Network; Evolved Universal Terrestrial Radio Access (E-UTRA); Further advancements for E-UTRA physical layer aspects (Release 9); 3GPP TR 36.814 V9.0.0 (March 2010); Section 9A, Heterogeneous Deployments

In ICIC described in Non-Patent Document 1 and CoMP described in Non-Patent Document 2, a network formed of base stations (for example, macro base stations) having identical transmission power (transmission capability), that is, a homogeneous network, is assumed. However, how to apply ICIC and CoMP to a heterogeneous network has not been specifically proposed in these documents.

In view of this situation, an object of the present invention is to use radio resources more efficiently while reducing interference between radio signals in a radio communication system that includes a plurality of types of radio base stations having different transmission powers (transmission capabilities) by using both inter-cell interference coordination and coordinated multiple point transmission and reception.

### SUMMARY OF THE INVENTION

A radio communication system according to the present invention includes a plurality of first radio base stations connected to each other and each of which forms a first cell; a plurality of second radio base stations each of which is connected to at least one of the first radio base stations and forms, in the first cell formed by the first radio base station to be connected, a second cell having a smaller area than the first cell; and a mobile station capable of executing radio communication by sending and receiving radio signals to and from each of the first radio base station and the second radio base station corresponding to resident cells in which the mobile station is located among the first cells and the second cells. The mobile station includes a measuring section that measures reception characteristics of radio signals sent from the first radio base station and the second radio base stations corresponding to the resident cells; and a reporting section that reports measurement results of the reception characteristics measured by the measuring section to the first radio base station corresponding to the resident cell. Each of the first radio base stations includes a decision section that decides a first radio base station and second radio base stations that send radio signals whose reception characteristics exceed a predetermined threshold according to the measurement results reported from the mobile station, to serve as a coordinated-transmission radio base station set for the mobile station; and a first radio communication section that executes radio communication synchronously with a second radio base station connected to the first radio base station, that executes transmission of a radio signal to the mobile station located in the first cell of the first radio base station in a first period, and that stops the transmission of the radio signal to the mobile station in a second period. Each of the second radio base stations includes a second radio communication section that executes radio communication synchronously with a first radio base station to which the second radio base station connects, and that executes transmission of a radio signal to the mobile station located in the second cell of the second radio base station in both the first period and the second period for the first radio base station to which the second radio base station connects. In the first period for the first radio base station, the first radio communication section of the first radio base station included in the coordinated-transmission radio base station set and the second radio communication sections of the second radio base stations included in the coordinated-transmission radio base station set are capable of coordinating with each other to send radio signals to the mobile terminal corresponding to the coordinated-transmission radio base station set, and in the second period for the first radio base station, the second radio communication sections of the second radio base stations included in the coordinated-transmission radio base station set are capable of coordinating with each other to send radio signals to the mobile terminal corresponding to the coordinated-transmission radio base station set.

In the above-described configuration, since a period in which the first radio base stations send radio signals is limited only to the first period, interference imposed by the first radio base stations on radio signals sent from the second radio base stations is reduced compared with a case in which the first radio base stations continue to send radio signals (send radio signals in the first period and the second period). In addition, since a plurality of radio base stations (first radio base stations and second radio base stations) coordinate with each other to send radio signals to the mobile station, the transmission of radio signals is more dynamically controlled, and interference between the radio signals is reduced. Therefore, the radio resources can be used more efficiently.

It is preferable that the first period and the second period for the first radio base station have an identical time length and come alternately.

In the above-described configuration, the first period and the second period are provided in the same way.

It is preferable that the allocation of the first periods and the second periods for the first radio base station be decided according to a number of radio base stations included in the coordinated-transmission radio base station set that includes the first radio base station.

In the above-described configuration, since the first periods and the second periods are allocated according to the number of radio base stations included in the coordinated-transmission base station set, interference between radio signals is reduced further, and the radio resources can be used more efficiently.

It is preferable that a number of first periods be set to be larger in a unit period as a number of radio base stations included in the coordinated-transmission radio base station set that includes the first radio base station increases.

In the above-described configuration, since the number of first periods in which the first radio base stations send radio signals is set to be larger as the number of radio base stations included in the coordinated-transmission base station set increases, the period in which more radio base stations send radio signals to the mobile station simultaneously is extended. Therefore, the effect of coordinated transmission can be enhanced.

It is preferable that the first radio communication sections of the first radio base stations be capable of executing radio communication synchronously with each other.

In the above-described configuration, since the first radio communication sections of the plurality of first radio base stations synchronize with each other, the second periods, in which none of the first radio base stations send radio signals (only the second radio base stations send radio signals) also synchronize with each other. Therefore, even if a mobile station is located in a plurality of first cells formed by the plurality of first radio base stations, interference between radio signals is reduced, and the mobile terminal can receive radio signals from the second radio base stations with high quality.

A communication control method according to the present invention is for a radio communication system provided with a plurality of first radio base stations connected to each other and each of which forms a first cell; a plurality of second radio base stations each of which is connected to at least one of the first radio base stations and forms, in the first cell formed by the first radio base station to be connected, a second cell having a smaller area than the first cell; and a mobile station capable of executing radio communication by sending and receiving radio signals to and from each of the first radio base station and the second radio base station corresponding to resident cells in which the mobile station is located among the first cells and the second cells. The communication control method includes: in the mobile station, measuring reception characteristics of radio signals sent from the first radio base station and the second radio base stations corresponding to the resident cells and reporting measurement results of the measured reception characteristics to the first radio base station corresponding to the resident cell; in each of the first radio base stations, deciding a first radio base station and second radio base stations that send radio signals whose reception characteristics exceed a predetermined threshold according to the measurement results reported from the mobile station, to serve as a coordinated-transmission radio base station set for the mobile station, and, when the first radio base station executes radio communication synchronously with a second radio base station connected to the first radio base station, executing transmission of a radio signal to the mobile station located in the first cell of the first radio base station in a first period, and stopping the transmission of the radio signal to the mobile station in a second period; in each of the second radio base stations, when the second radio base station executes radio communication synchronously with a first radio base station to which the second radio base station connects, executing transmission of a radio signal to the mobile station located in the second cell of the second radio base station in both the first period and the second period for the first radio base station to which the second radio base station connects; in the first period for the first radio base station, the first radio base station included in the coordinated-transmission radio base station set and the second radio base stations included in the coordinated-transmission radio base station set coordinating with each other to send radio signals to the mobile terminal corresponding to the coordinated-transmission radio base station set; and in the second period for the first radio base station, the second radio base stations included in the coordinated-transmission radio base station set coordinating with each other to send radio signals to the mobile terminal corresponding to the coordinated-transmission radio base station set.

### BRIEF DESCRIPTION OF THE DRAWINGS

FIG. 1 is a block diagram showing a radio communication system according to a first embodiment of the present invention.

FIG. 2 is a block diagram showing the configuration of a user equipment according to the first embodiment of the present invention.

FIG. 3 is a block diagram showing the configuration of a macro base station according to the first embodiment of the present invention.

FIG. 4 is a block diagram showing the configuration of a pico base station according to the first embodiment of the present invention.

FIG. 5 is a view showing the format of a radio frame transmitted and received in the radio communication system.

FIG. 6 is an outline view of inter-cell interference coordination (eICIC) according to the first embodiment of the present invention.

FIG. 7 is an outline view of coordinated multiple point transmission and reception (CoMP) according to the first embodiment of the present invention.

FIG. 8 is a flowchart showing how a coordinated-transmission base station set (CoMP set) is decided in the coordinated multiple point transmission and reception.

FIG. 9 is a view showing communication control performed when both eICIC and CoMP according to the first embodiment of the present invention are used.

FIG. 10 is a block diagram showing a radio communication system according to a second embodiment of the present invention.

FIG. 11 is a view showing communication control performed when both eICIC and CoMP according to the second embodiment of the present invention are used.

FIG. 12 is a view showing an example case of eICIC according to a modification of the present invention.

### DESCRIPTION OF EMBODIMENTS

### First Embodiment

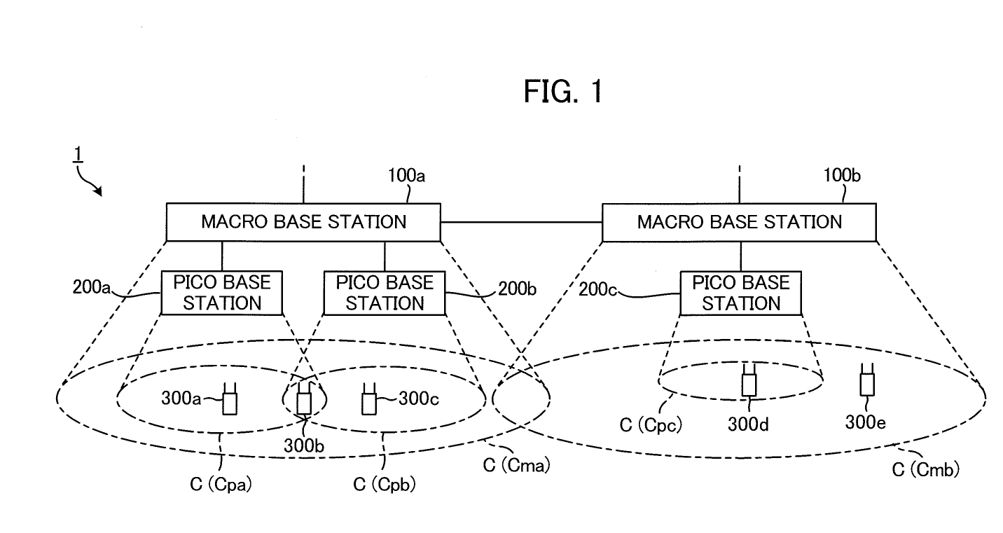

FIG. 1 is a block diagram showing a radio communication system 1 according to a first embodiment of the present invention. The radio communication system 1 includes a plurality of macro base stations (macro evolved node B (eNodeB)) 100 (100a and 100b), a plurality of pico base stations (pico eNodeB) 200 (200a to 200c), and a plurality of user equipments 300 (300a to 300e). Communication elements (such as the macro base stations 100, the pico base stations 200, and the user equipments 300) in the radio communication system 1 each perform radio communication according to a predetermined radio access technology, such as long term evolution (LTE).

In the present embodiment, an example case will be described in which the radio communication system 1 operates according to LTE, but there is no intention to limit the technical scope of the present invention. The present invention can also be applied to other radio access technologies (for example, WiMAX, stipulated in IEEE 802.16) after necessary design changes are made.

The plurality of macro base stations 100 are connected to each other by wire or by radio. Each of the macro base stations 100 is also connected to a core network, not shown. Each of the macro base stations 100 forms therearound a macro cell Cm, which is an area where radio communication is possible. Each of the plurality of pico base stations 200 is connected to at least one macro base station 100 by wire or by radio. Each of the pico base stations 200 forms therearound a pico cell Cp, which is an area where radio communication is possible. A pico cell Cp (for example, pico cell Cpa) is formed inside the macro cell Cm (for example, macro cell Cma) formed by the macro base station 100 (for example, macro base station 100a) to which the pico base station 200 (for example, pico base station 200a) that forms the pico cell Cp is connected. Inside one macro cell Cm (for example, macro cell Cma), a plurality of pico cells Cp (for example, pico cell Cpa and pico cell Cpb) can be formed.

Each of the base stations (the macro base stations 100 and the pico base stations 200) can communicate by radio with a user equipment (user equipment, UE) 300 located in the cell C of that base station by exchanging radio waves (radio signals). Conversely, a user equipment 300 can communicate by radio with the base station (macro base station 100, pico base station 200) corresponding to the cell C (macro cell Cm, pico cell Cp) in which that user equipment 300 is located, by exchanging radio waves (radio signals).

Since the macro base stations 100 have a higher radio transmission capability (maximum transmission power, average transmission power, etc.) than the pico base stations 200, the macro base stations 100 can communicate by radio with user equipments 300 located farther away. Therefore, the macro cells Cm are larger in area than the pico cells Cp. For example, the macro cells Cm have a radius of about several hundred meters to several tens of kilometers, whereas the pico cells Cp have a radius of about several meters to several tens of meters.

As understood from the foregoing description, the macro base stations 100 and the pico base stations 200 in the radio communication system 1 form a heterogeneous network, in which a plurality of types of radio base stations having different transmission powers (transmission capabilities) are provided in a multi-layer manner (see Non-Patent Document 3).

Since the pico cells Cp are formed inside the macro cell Cm in a multi-layer manner (are overlaid thereon), when a user equipment 300 is located in a pico cell Cp, it can be understood that the user equipment 300 can communicate by radio with both the pico base station 200 forming that pico cell Cp and the macro base station 100 forming the macro cell Cm that includes the pico cell Cp. As shown in FIG. 1, for example, when a user equipment 300b is located in a plurality of pico cells Cpa and Cpb, it can be understood that the user equipment 300 can communicate by radio with the pico base stations 200a and 200b forming the pico cells Cpa and Cpb, respectively, and also with the macro base station 100a forming the macro cell Cma that includes the pico cells Cpa and Cpb.

Any radio communication method can be used between each base station (macro base station 100, pico base station 200) and a user equipment 300. For example, orthogonal frequency division multiple access (OFDMA) may be employed for downlink, and single-carrier frequency division multiple access (SC-FDMA) may be employed for uplink.

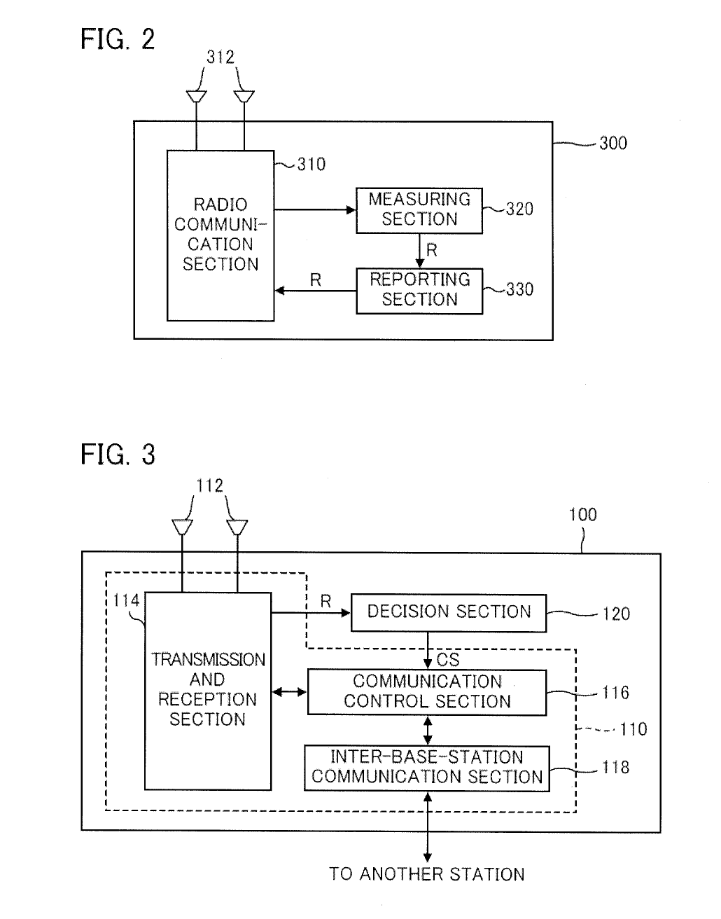

FIG. 2 is a block diagram showing the configuration of the user equipment 300 according to the first embodiment of the present invention. The user equipment 300 includes a radio communication section 310, a measuring section 320, and a reporting section 330. For convenience, an output unit for outputting sound or video, an input unit for accepting instructions from the user, and other units are omitted in the figure.

The radio communication section 310 executes radio communication with a base station (macro base station 100, pico base station 200). The radio communication section 310 includes transmission and reception antennas 312, a receiving circuit for receiving radio waves (radio signal) from a base station and converting them to an electrical signal, and a transmission circuit for converting an electrical signal, such as a voice signal, to radio waves and sending them. When the radio communication section 310 receives a radio signal of a plurality of lines, sent from a plurality of base stations in coordination with each other, the receiving circuit may converts only the radio signal of a line having a large reception intensity to an electrical signal, may convert the radio signal multiplexed in space to an electrical signal as is, or may convert radio signals of the respective lines, separated individually, to electrical signals. Details of coordinated transmission (CoMP transmission) conducted by base stations will be described later.

The measuring section 320 measures the reception power (reference signal received power, RSRP) of a radio signal sent by each base station (macro base station 100, pico base station 200) corresponding to the cell C where the user equipment 300 is located and received by the radio communication section 310 of the user equipment 300 to obtain a measurement result R (characteristic value indicating the measured reception power). The reception power (characteristic value) at the user equipment 300 decreases the farther the user equipment 300 is located from each base station. The obtained measurement result R (each characteristic value) is supplied to the reporting section 330.

The reporting section 330 reports the measurement result R (each characteristic value) obtained by the measurement at the measuring section 320 to the macro base station 100 connected by radio, through the radio communication section 310.

The measuring section 320 and the reporting section 330 can be functional blocks implemented when a central processing unit (CPU), not shown, included in the user equipment 300 executes a computer program stored in a storage section, not shown, and functions according to the computer program.

FIG. 3 is a block diagram showing the configuration of the macro base station 100 according to the embodiment of the present invention. The macro base station 100 includes a radio communication section 110, and a decision section 120. The radio communication section 110 includes a transmission and reception section 114 connected to transmission and reception antennas 112, a communication control section 116, and an inter-base-station communication section 118.

The transmission and reception section 114 executes radio communication with a user equipment 300. The transmission and reception section 114 includes a receiving circuit for receiving a radio signal from the user equipment 300 and converting it to an electrical signal, and a transmission circuit for converting an electrical signal, such as a voice signal, to a radio signal and sending it. The communication control section 116 controls radio communication executed by the transmission and reception section 114. For example, the communication control section 116 changes the transmission power used when the transmission and reception section 114 sends a radio signal, which includes making the transmission power zero, that is, stopping the transmission of a radio signal. The inter-base-station communication section 118 communicates with another base station (macro base station 100, pico base station 200) connected to the macro base station 100, and with a core network, not shown.

The decision section 120 decides, according to the measurement result R (each characteristic value) reported from the reporting section 330 of the user equipment 300, base stations (macro base station 100, pico base station 200) that send radio signals whose characteristic values exceed a predetermined threshold Th, to serve as a coordinated-transmission base station (CoMP) set CS, which is a combination of base stations that coordinate with each other to send radio signals to the user equipment 300. The decided coordinated-transmission base station set CS is supplied to the communication control section 116. The predetermined threshold Th is stored in a storage section, not shown, of the macro base station 100.

The macro base station 100 sends and receives an electrical signal through the inter-base-station communication section 118 to and from another base station and executes mutual control (coordination). In particular, the macro base station 100 coordinates with each base station included in the coordinated-transmission base station set CS to send radio signals to the user equipment 300 corresponding to the coordinated-transmission base station set CS. The inter-base-station communication sections of the base stations can be connected to each other by using any connection technology (for example, optical fiber or an X2 interface). As described earlier, since the macro base station 100 and the pico base station 200 coordinate with each other to send radio signals, it is preferable that the macro base station 100 and the pico base station 200 are connected to each other by a high-speed, large-capacity connection technology having a small transmission delay (for example, optical fiber connection). When the macro base station 100 communicates with another base station by radio, the inter-base-station communication section 118 may send and receive radio signals through the radio communication section 110 to and from each other to execute mutual control (coordination).

The communication control section 116 and the inter-base-station communication section 118 included in the radio communication section 110, and the decision section 120 can be functional blocks implemented when a CPU, not shown, included in the macro base station 100 executes a computer program stored in a storage section, not shown, and functions according to the computer program.

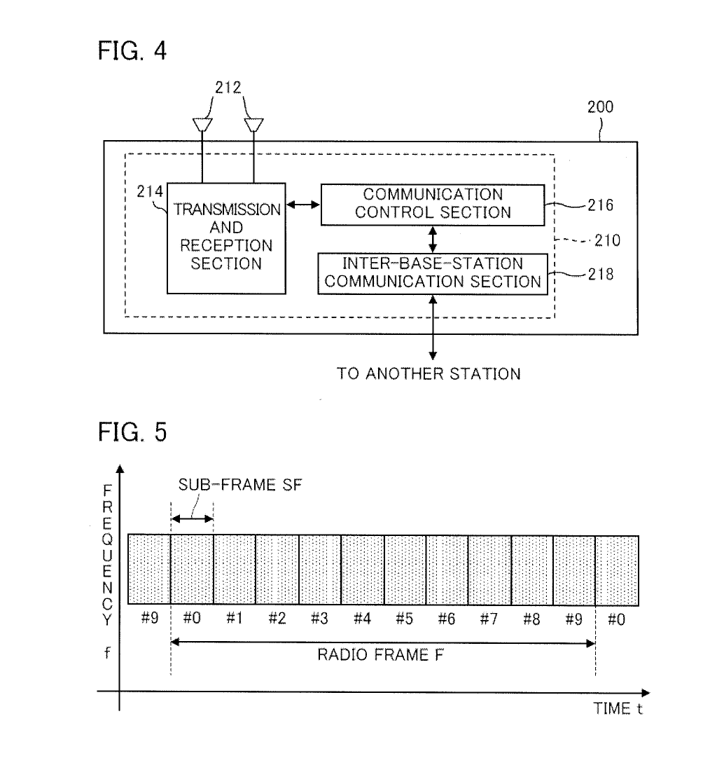

FIG. 4 is a block diagram showing the configuration of the pico base station 200 according to the embodiment of the present invention. The pico base station 200 includes a radio communication section 210. The radio communication section 210 includes a transmission and reception section 214 connected to transmission and reception antennas 212, a communication control section 216, and an inter-base-station communication section 218.

The transmission and reception section 214 executes radio communication with a user equipment 300. The transmission and reception section 214 includes a receiving circuit for receiving a radio signal from the user equipment 300 and converting it to an electrical signal, and a transmission circuit for converting an electrical signal, such as a voice signal, to a radio signal and sending it. The communication control section 216 controls radio communication executed by the transmission and reception section 214. For example, the communication control section 216 changes the transmission power used when the transmission and reception section 214 sends a radio signal, which includes making the transmission power zero, that is, stopping the transmission of a radio signal. The inter-base-station communication section 218 communicates with the macro base station 100 connected to the pico base station 200. The pico base station 200 sends and receives an electrical signal through the inter-base-station communication section 218 to and from the macro base station 100 and executes mutual control (coordination). When the pico base station 200 communicates with the macro base station 100 by radio, the inter-base-station communication section 218 and the inter-base-station communication section 118 may exchange radio signals with each other through the radio communication section 210 to execute mutual control (coordination).

The pico base station 200 can receive information sent from the macro base station 100 and forward the information to the user equipment 300, and can receive information sent from the user equipment 300 and forward the information to the macro base station 100. More specifically, the communication control section 216 supplies, to the transmission and reception section 214, an electrical signal which the inter-base-station communication section 218 of the pico base station 200 receives from the macro base station 100. The transmission and reception section 214 converts the supplied electrical signal to a radio signal and sends it to the user equipment 300. The communication control section 216 also supplies, to the inter-base-station communication section 218, an electrical signal obtained through receiving and conversion by the transmission and reception section 214 of the pico base station 200. The inter-base-station communication section 218 sends the supplied electrical signal to the macro base station 100. With the above-described configuration, even if it is difficult for the user equipment 300 to communicate with the macro base station 100 by radio because the user equipment 300 is close to the pico base station 200, necessary information can be exchanged between the user equipment 300 and the macro base station 100.

The communication control section 216 and the inter-base-station communication section 218 included in the radio communication section 210 can be functional blocks implemented when a CPU, not shown, included in the pico base station 200 executes a computer program stored in a storage section, not shown, and functions according to the computer program.

FIG. 5 is a view showing the format of a radio frame F exchanged between communication elements in the radio communication system 1. The radio frame F is a transmission unit of a radio signal sent by each of the communication elements (macro base stations 100, pico base stations 200, user equipments 300, and others) and occupies a predetermined time length (for example, 10 ms) and a predetermined frequency band f. A series of radio signals are formed when the radio frames F are sent consecutively.

The radio frame F includes a plurality of sub-frames SF. A sub-frame SF is a transmission unit occupying a shorter time length (for example, 1 ms) than the radio frame F. In one radio frame F, numbers are assigned to sub-frames SF from zero (#0) in ascending order.

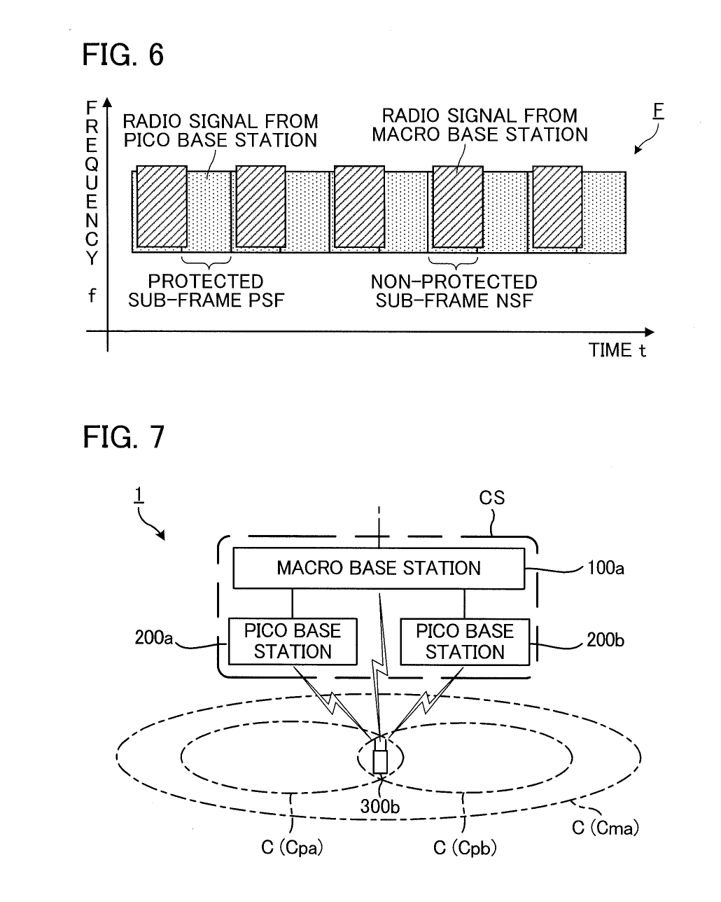

FIG. 6 is an outline view of enhanced inter-cell interference coordination (eICIC) according to the first embodiment of the present invention. ICIC executed in a heterogeneous network is called eICIC.

To explain eICIC, it is assumed here that a macro base station 100 and a pico base station 200 that forms a pico cell Cp in the macro cell Cm formed by the macro base station 100 use the same radio frame timing and the same frequency band f to send radio signals (radio frames F). Sending radio signals at the same radio frame timing means that the transmission start time of radio frames F sent by the macro base station 100 is the same as the transmission start time of radio frames F sent by the pico base station 200. In other words, the radio communication section 110 of the macro base station 100 and the radio communication section 210 of the pico base station 200 can perform radio communication synchronously.

In the above case, since the radio signal from the macro base station 100 and the radio signal from the pico base station 200 are sent in the same frequency band f, they interfere with each other. In particular, since the macro base station 100 has a larger transmission power than the pico base station 200, the radio signal from the macro base station 100 interferes strongly with the radio signal from the pico base station 200. Therefore, if both the radio signals are always sent continuously, it is difficult for the user equipment 300 to receive the radio signal from the pico base station 200.

In view of the above-described situation, the radio communication section 110 of the macro base station 100 sends the radio signal to the user equipment 300 intermittently according to a pattern of sub-frames SF determined statically in advance, in eICIC of the present invention. Specifically, as shown in FIG. 6, the communication control section 116 of the radio communication section 110 controls the transmission and reception section 114 such that the transmission of the radio signal is alternately executed and stopped every sub-frame SF. Since the radio signal from the pico base station 200 is protected from the interference caused by the macro base station 100, sub-frames SF in which the transmission of the radio signal from the macro base station 100 is stopped are called protected sub-frames PSF. In contrast, sub-frames SF in which the transmission of the radio signal from the macro base station 100 is executed are called non-protected sub-frames NSF.

On the other hand, the radio communication section 210 of the pico base station 200 sends the radio signal to the user equipment 300 continuously, that is, in both non-protected sub-frames NSF and protected sub-frames PSF.

With the above-described configuration, in protected sub-frames PSF where the radio communication section 110 of the macro base station 100 does not send the radio signal, only the radio communication section 210 of the pico base station 200 sends the radio signal. Therefore, since the radio signal from the macro base station 100 does not interfere with the radio signal from the pico base station 200 in protected sub-frames PSF, a user equipment 300 that is located in both the macro cell Cm formed by the macro base station 100 and the pico cell Cp formed by the pico base station 200 can receive the radio signal from the pico base station 200 with higher quality.

FIG. 7 is an outline view of inter-cell coordinated multiple point transmission and reception (CoMP) according to the first embodiment of the present invention. To explain CoMP, it is assumed, as in FIG. 1, that the user equipment 300b is located in the macro cell Cma formed by the macro base station 100a and also in the pico cell Cpa and the pico cell Cpb formed by the pico base station 200a and the pico base station 200b, respectively. The macro base station 100a, the pico base station 200a, and the pico base station 200b corresponding to the user equipment 300b form a coordinated-transmission base station (CoMP) set CS, described later.

The base-station group forming the coordinated-transmission base station set CS (macro base station 100a, pico base station 200a, and pico base station 200b) executes the transmission of radio signals in a coordinated fashion (coordinated transmission) to the user equipment 300b corresponding to the coordinated-transmission base station set CS under the control of the macro base station 100a. Any coordinated transmission can be executed, but, for example, a base station other than a specific base station (for example, a base station that sends a radio signal having the highest reception quality at the user equipment 300) may reduce the transmission power of a radio signal to the user equipment 300b among the base stations included in the coordinated-transmission base station set CS, or a plurality of base stations included in the coordinated-transmission base station set CS may send radio signals indicating identical data to the user equipment 300b. With this coordinated transmission, interference among radio signals can be reduced.

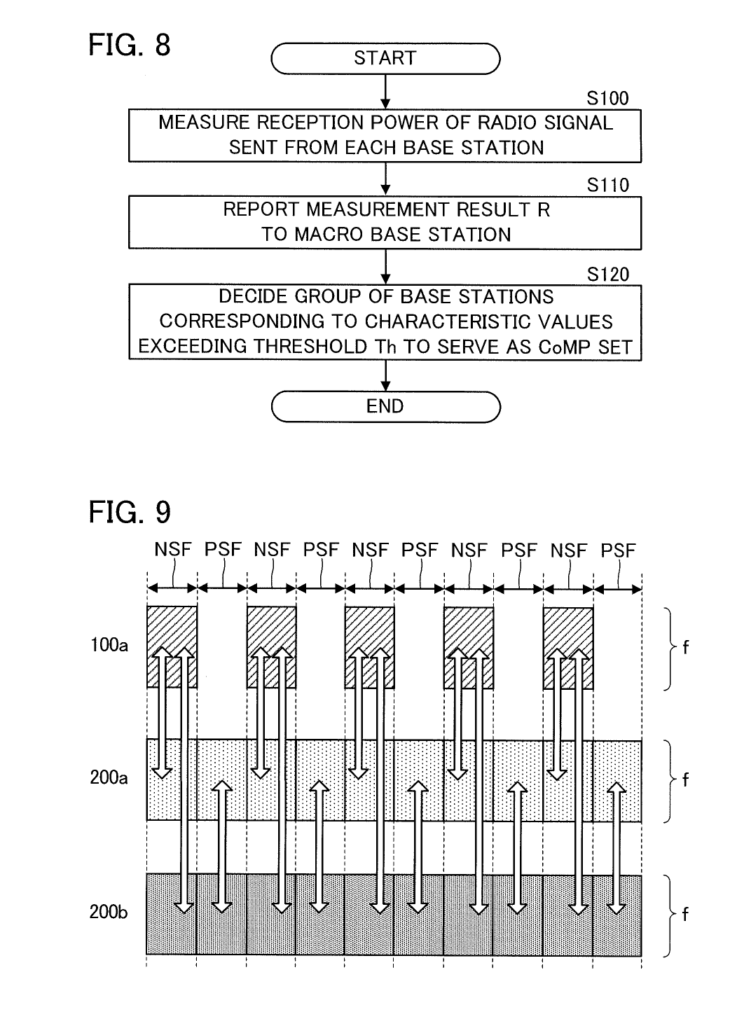

FIG. 8 is a flowchart showing how the coordinated-transmission base station set is decided by the macro base station 100 and the user equipment 300. The measuring section 320 of the user equipment 300 measures the reception power of a radio signal from each base station (macro base station 100, pico base station 200) corresponding to a resident cell to obtain a measurement result R (characteristic value indicating the reception power) (step S100). The reporting section 330 of the user equipment 300 reports the measurement result R to the macro base station 100 (step S110). The decision section 120 of the macro base station 100 compares each characteristic value (the measurement result R) reported from the reporting section 330 of the user equipment 300 with a predetermined threshold Th and decides (selects) base stations (macro base station 100, pico base station 200) corresponding to the characteristic values exceeding the threshold Th to serve as a coordinated-transmission base station set CS (step S120). With these steps, the macro base station 100 decides the coordinated-transmission base station set CS. The macro base station 100 and the user equipment 300 can execute the operation in the flowchart shown in FIG. 8 at any timing (preferably, at predetermined intervals or when handover is executed).

The radio communication system 1 of the present invention uses the radio resources (e.g., transmission time (radio frame F)) more efficiently by using both eICIC and CoMP, described above. FIG. 9 is a view showing an example of communication control performed when both eICIC and CoMP are used.

In FIG. 9, it is assumed in the same way as in FIG. 1 and FIG. 7 that the user equipment 300b is located in the macro cell Cma formed by the macro base station 100a and also in the pico cell Cpa and the pico cell Cpb formed by the pico base station 200a and the pico base station 200b, respectively. The coordinated-transmission base station set CS for the user equipment 300b includes the macro base station 100a, the pico base station 200a, and the pico base station 200b. The base stations included in the coordinated-transmission base station set CS execute radio communication in the same frequency band f in synchronization with each other through the inter-base-station communication sections (118, 218).

The macro base station 100a executes eICIC in the same way as in FIG. 6. Specifically, the communication control section 116 of the macro base station 100a performs control such that the transmission and reception section 114 of the radio communication section 110 executes transmission of a radio signal in non-protected sub-frames NSF, and such that the transmission and reception section 114 of the radio communication section 110 stops the transmission of the radio signal in protected sub-frames PSF.

On the other hand, the pico base station 200a and the pico base station 200b send radio signals to the user equipment 300b in both non-protected sub-frames NSF and protected sub-frames PSF.

In non-protected sub-frames NSF for the macro base station 100, the radio communication sections (110, 210) of the macro base station 100a, the pico base station 200a, and the pico base station 200b, which are included in the coordinated-transmission base station set CS and execute radio communication, coordinate with each other through the inter-base-station communication sections (118, 218) to send radio signals to the user equipment 300b corresponding to the coordinated-transmission base station set CS. On the other hand, in protected sub-frames NSF for the macro base station 100, the radio communication sections (210) of the pico base station 200a and the pico base station 200b, which are included in the coordinated-transmission base station set CS and execute radio communication, coordinate with each other through the inter-base-station communication sections (218) to send radio signals to the user equipment 300b corresponding to the coordinated-transmission base station set CS.

In other words, in non-protected sub-frames NSF, all of the macro base station 100 and the plurality of pico base stations 200 included in the coordinated-transmission base station set CS execute coordinated transmission, whereas, in protected sub-frames PSF, only the plurality of pico base stations 200 included in the coordinated-transmission base station set CS execute coordinated transmission.

It is not necessary to execute COMP in the whole period (all sub-frames SF). For example, when a user equipment 300 is located only in the macro cell Cm formed by one macro base station 100 (for example, the user equipment 300e, which is located only in the macro cell Cmb in FIG. 1), the macro base station 100 does not need to execute CoMP but needs to send a radio signal to the user equipment 300 in non-protected sub-frames NSF. In another example, when a user equipment 300 is located in the macro cell Cm formed by one macro base station 100 and in the pico cell Cp formed by one pico base station 200 (for example, the user equipment 300a, which is located in the macro cell Cma and the pico cell Cpa in FIG. 1), the pico base station 200 does not need to execute CoMP but needs to send a radio signal to the user equipment 300 in protected sub-frames PSF. In other words, CoMP needs to be executed when there are a plurality of base stations that should send radio signals to a user equipment 300.

In the above-described embodiment, since sub-frames SF in which the macro base station 100 sends a radio signal are limited only to non-protected sub-frames NSF due to the execution of eICIC, interference imposed by the macro base station 100 on a radio signal sent from the pico base station 200 is reduced in comparison with a case in which the macro base station 100 continues to send a radio signal (eICIC is not executed). In addition, since a plurality of base stations (macro base station 100, pico base station 200) coordinate with each other to send radio signals to the user equipment 300, the transmission of the radio signals can be dynamically controlled in comparison with a case in which only inter-cell interference coordination is employed. Therefore, interference between radio signals is further reduced. Consequently, the radio resources can be used more efficiently.

### Second Embodiment

A second embodiment of the present invention will be described below. For units having the same effects or functions in the following example embodiment and modifications as in the first embodiment, the reference symbols used in the above description will be used again and a detailed description thereof will be omitted, if unnecessary.

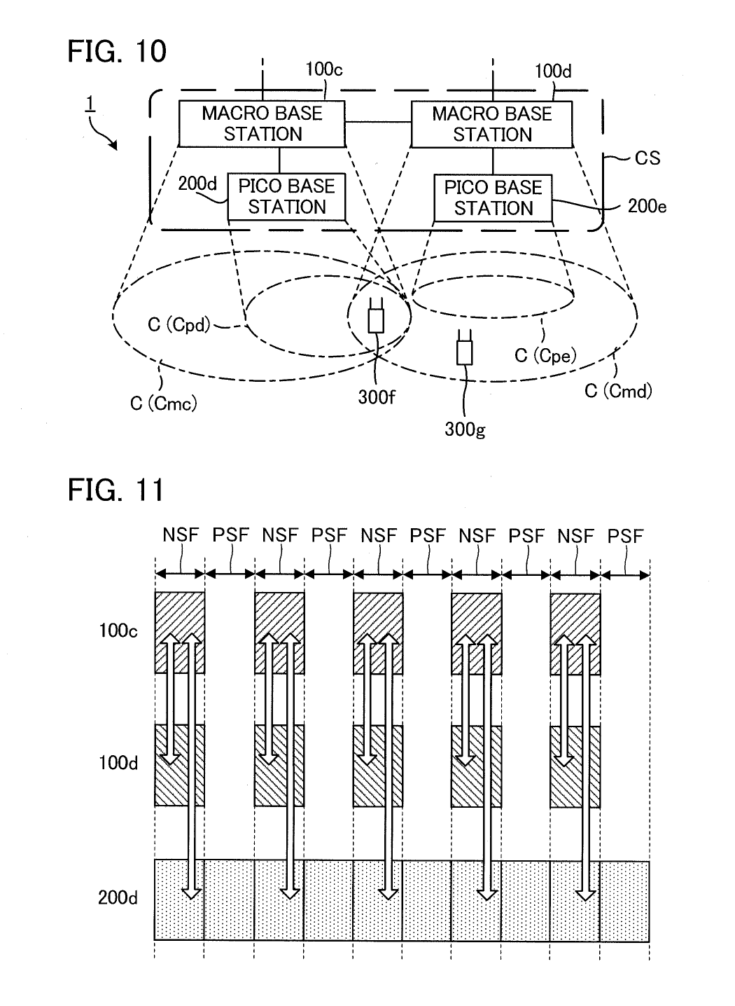

FIG. 10 is a block diagram showing a radio communication system 1 according to the second embodiment of the present invention. The radio communication system 1 includes a plurality of macro base stations 100 (100c and 100d), a plurality of pico base stations 200 (200d and 200e), and a plurality of user equipments 300 (300f and 300g). The pico cell Cpd formed by the pico base station 200d so as to be included in the macro cell Cmc formed by the macro base station 100c also overlaps with a macro cell Cmd.

The user equipment 300f is located at an area where the macro cell Cmc, the macro cell Cmd, and the pico cell Cpd overlap. Therefore, the user equipment 300f can receive radio signals from the macro base station 100c, the macro base station 100d, and the pico base station 200d corresponding to the cells C (Cmc, Cmd, and Cpd).

FIG. 11 is a view showing example communication control performed when both eICIC and CoMP according to the second embodiment are used. The coordinated-transmission base station set CS for the user equipment 300f includes the macro base station 100c, the macro base station 100d, and the pico base station 200d, which send radio signals having transmission powers (characteristic values) exceeding the predetermined threshold Th. The base stations included in the coordinated-transmission base station set CS execute radio communication in an identical frequency band f synchronously with each other through the inter-base-station communication sections (118, 218).

In eICIC shown in FIG. 11, the macro base station 100c and the macro base station 100d send radio signals by using common non-protected sub-frames NSF and protected sub-frames PSF (in other words, synchronously with each other) under the control of the inter-base-station communication sections 118. In other words, when the macro base station 100c sends a radio signal, the macro base station 100d also sends a radio signal; and when the macro base station 100c stops the transmission of the radio signal, the macro base station 100d also stops the transmission of the radio signal.

On the other hand, the pico base station 200d sends a radio signal to the user equipment 300f in both non-protected sub-frames NSF and protected sub-frames PSF.

One of the macro base stations 100 which serves as a main station (for example, the macro base station 100 to which the user equipment 300f first connects) may control the other macro base station 100 which serves as a subordinate station, or the two macro base stations 100 may control each other in coordination.

In the non-protected sub-frames NSF, the radio communication sections (110, 210) of the macro base station 100c, the macro base station 100d, and the pico base station 200d included in the coordinated-transmission base station set CS coordinate with each other through the inter-base-station communication sections (118, 218) to send radio signals to the user equipment 300f corresponding to the coordinated-transmission base station set CS. In the protected sub-frames PSF, the radio communication section 210 of the pico base station 200d sends a radio signal to the user equipment 300f.

When the user equipment 300f is located in a plurality of pico cells Cp, it is understood as a matter of course that, even in the protected sub-frames PSF, the plurality of pico base stations 200 can execute coordinated transmission (CoMP transmission).

The above-described embodiment achieves the same advantages as the first embodiment. In addition, since the radio communication sections 110 of a plurality of macro base stations 100 execute radio communication synchronously with each other, a period in which no macro base stations 100 send radio signals but only the pico base station 200 sends a radio signal (protected sub-frames PSF) is obtained. Therefore, even if a user equipment 300 is located in the macro cells Cm of a plurality of macro base stations 100, interference between radio signals can be reduced, and the user equipment 300 can receive the radio signal from the pico base station 200 with high quality.

### MODIFICATIONS

The embodiments described above can be modified in various ways. Specific example modifications will be described below. Two or more of the following modifications selected in a desired manner can be appropriately combined so long as no mutual contradiction occurs.

### Modification 1

In the above-described embodiments, base stations included in a coordinated-transmission base station set CS are decided (selected) according to the characteristic values obtained from the measured reception powers (RSRP) of radio waves. The characteristic values may be obtained from the signal to interference-and-noise ratio (SINR), the reference signal received quality (RSRQ), or the like.

### Modification 2

In the above-described embodiments, the decision section 120 of the macro base station 100 compares the characteristic value measured by the measuring section 320 of the user equipment 300 with the predetermined threshold Th. However, the user equipment 300 may compare the characteristic value with the threshold Th. Specifically, the user equipment 300 may include a storage section, not shown, that stores the threshold Th, and the measuring section 320 may compare the characteristic value obtained by measuring the reception power of a radio signal sent from each base station with the threshold Th and may supply the reporting section 330 with information indicating base stations (macro base station 100, pico base station 200) that send radio signals exceeding the threshold Th as measurement results R. In that case, the decision section 120 of the macro base station 100 can decide the coordinated-transmission base station set CS for the user equipment 300 according to the measurement results R reported by the reporting section 330 of the user equipment 300, the measurement results R indicating the base stations that send radio signals whose characteristic values (reception powers) exceed the threshold Th.

### Modification 3

In the above-described embodiments, the pico base stations 200 are exemplified as base stations having a lower transmission capability than the macro base stations 100. A micro base station, a nano base station, a femto base station, a remote radio head, or the like may be used as a base station having a lower transmission capability.

In particular, as an element of the radio communication system 1, a combination of a plurality of base stations having different transmission capabilities (for example, a combination of a macro base station, a pico base station, and a femto base station) may be employed.

### Modification 4

In the above-described embodiments, the pattern of sub-frames SF (the allocation of non-protected sub-frames NSF and protected sub-frames PSF) is determined statically. However, the pattern of sub-frames SF may be determined quasi-statically. For example, when a pico base station 200 is added or removed according to necessity during the operation of the macro base station 100, the allocation of non-protected sub-frames NSF and protected sub-frames PSF may be changed according to the number of pico base stations 200 included in the coordinated-transmission base station set CS of the macro base station 100.

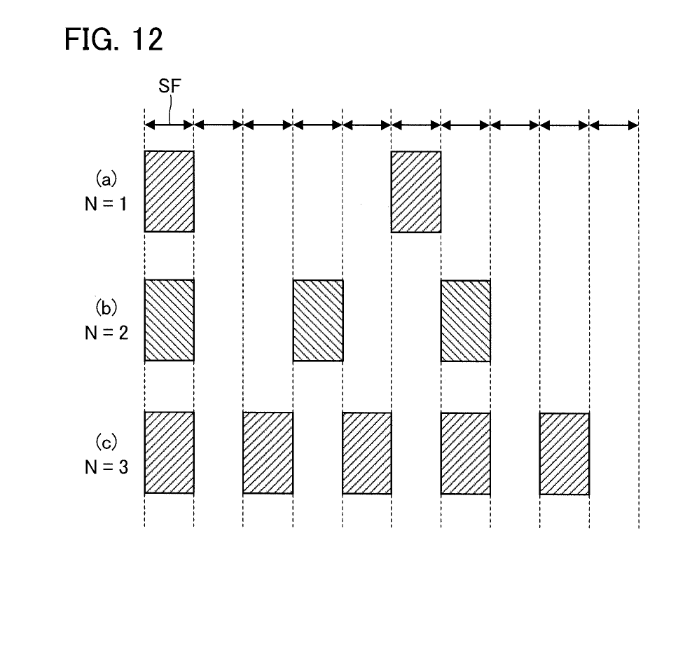

For example, in view of the fact that the effect of CoMP is enhanced as the number of base stations increases, the communication control section 116 of the macro base station 100 may perform control such that the number of non-protected sub-frames NSF becomes larger in the radio frame F as the number, N, of pico base stations 200 included in the coordinated-transmission base station set CS that includes the macro base station 100 increases. In an example shown in FIG. 12, the communication control section 116 sets the number of non-protected sub-frames NSF to two when the number, N, of pico base stations 200 included in the coordinated-transmission base station set CS is one (FIG. 12(a)), sets the number of non-protected sub-frames NSF to three when the number, N, of pico base stations 200 is two (FIG. 12(b)), and sets the number of non-protected sub-frames NSF to five when the number, N, of pico base stations 200 is three (FIG. 12(c)). This setting operation can be executed at relatively long intervals (for example, at one-hour intervals).

When interference imposed by the macro base station 100 on a radio signal sent from the pico base station 200 has a larger effect than CoMP, it is possible to employ a configuration in which the number of protected sub-frames PSF becomes larger in the radio frame F as the number, N, of pico base stations 200 included in the coordinated-transmission base station set CS increases, which is opposite to the example shown in FIG. 12.

In this modification, the communication control section 116 of the macro base station 100 may control the number of non-protected sub-frames NSF not according to the number, N, of pico base stations 200 but according to the total number of base stations (macro base stations 100, pico base stations 200) included in the coordinated-transmission base station set CS.

### Modification 5

In the second embodiment, the macro base station 100c and the macro base station 100d send radio signals synchronously with each other. However, these macro base stations 100 do not necessarily synchronize with each other. This is because interference on a radio signal sent from the pico base station 200 is reduced when the transmission of a radio signal from any of the macro base stations 100 is stopped, compared with a case in which all the macro base stations 100 send radio signals. It is also because, when the protected sub-frames PSF for the macro base stations 100 have parts in common even if they do not match, only the pico base station 200 sends a radio signal in the common protected sub-frames. In addition, since the synchronization of the macro base stations 100 is not necessary, the configuration can be simplified.

### Modification 6

The user equipments 300 are devices capable of communicating with each base station (macro base station 100, pico base station 200) by radio. For example, the user equipments 300 may be cellular telephone terminals, such as feature phones or smart phones, desktop personal computers, notebook personal computers, ultra-mobile personal computers (UMPC), portable game machines, or other radio terminals.

### Modification 7

The functions executed by the CPU in each element (macro base station 100, pico base stations 200, and user equipments 300) in the radio communication system 1 may be executed by hardware instead of the CPU, or may be executed by a programmable logic device, such as a field programmable gate array (FPGA) or a digital signal processor (DSP).

### REFERENCE NUMERALS

100: Macro base station
110: Radio communication section
112: Transmission and reception antennas
114: Transmission and reception section
116: Communication control section
118: Inter-base-station communication section
120: Decision section
200: Pico base station
210: Radio communication section
212: Transmission and reception antennas
214: Transmission and reception section
216: Communication control section
218: Inter-base-station communication section
300: User equipment
310: Radio communication section
312: Transmission and reception antennas
320: Measuring section
330: Reporting section
C: Cell
CS: Coordinated transmission base station set
Cm: Macro cell
Cp: Pico cell
F: Radio frame
N: Count
NSF: Non-protected sub-frame
PSF: Protected sub-frame
R: Characteristic value
SF: Sub-frame
Th: Threshold
f: Frequency band

1. A radio communication system comprising:
a plurality of first radio base stations connected to each other and each of which forms a first cell;
a plurality of second radio base stations each of which is connected to at least one of the first radio base stations and forms, in the first cell formed by the first radio base station to be connected, a second cell having a smaller area than the first cell; and
a mobile station capable of executing radio communication by sending and receiving radio signals to and from each of the first radio base station and the second radio base station corresponding to resident cells in which the mobile station is located among the first cells and the second cells;
wherein the mobile station comprises:
a measuring section that measures reception characteristics of radio signals sent from the first radio base station and the second radio base stations corresponding to the resident cells; and
a reporting section that reports measurement results of the reception characteristics measured by the measuring section to the first radio base station corresponding to the resident cell;
wherein each of the first radio base stations comprises:
a decision section that decides a first radio base station and second radio base stations that send radio signals whose reception characteristics exceed a predetermined threshold according to the measurement results reported from the mobile station, to serve as a coordinated-transmission radio base station set for the mobile station; and
a first radio communication section that executes radio communication synchronously with a second radio base station connected to the first radio base station, that executes transmission of a radio signal to the mobile station located in the first cell of the first radio base station in a first period, and that stops the transmission of the radio signal to the mobile station in a second period;
wherein each of the second radio base stations comprises a second radio communication section that executes radio communication synchronously with a first radio base station to which the second radio base station connects, and that executes transmission of a radio signal to the mobile station located in the second cell of the second radio base station in both the first period and the second period for the first radio base station to which the second radio base station connects;
wherein, in the first period for the first radio base station, the first radio communication section of the first radio base station included in the coordinated-transmission radio base station set and the second radio communication sections of the second radio base stations included in the coordinated-transmission radio base station set are capable of coordinating with each other to send radio signals to the mobile terminal corresponding to the coordinated-transmission radio base station set, and
wherein, in the second period for the first radio base station, the second radio communication sections of the second radio base stations included in the coordinated-transmission radio base station set are capable of coordinating with each other to send radio signals to the mobile terminal corresponding to the coordinated-transmission radio base station set.

2. The radio communication system according to claim 1, wherein the first period and the second period for the first radio base station have an identical time length and come alternately.

3. The radio communication system according to claim 1, wherein the allocation of the first periods and the second periods for the first radio base station is decided according to a number of radio base stations included in the coordinated-transmission radio base station set that includes the first radio base station.

4. The radio communication system according to claim 3, wherein a number of first periods is set to be larger in a unit period as a number of radio base stations included in the coordinated-transmission radio base station set that includes the first radio base station increases.

5. The radio communication system according to claim 2, wherein the first radio communication sections of the first radio base stations are capable of executing radio communication synchronously with each other.

6. A communication control method for a radio communication system provided with a plurality of first radio base stations connected to each other and each of which forms a first cell; a plurality of second radio base stations each of which is connected to at least one of the first radio base stations and forms, in the first cell formed by the first radio base station to be connected, a second cell having a smaller area than the first cell; and a mobile station capable of executing radio communication by sending and receiving radio signals to and from each of the first radio base station and the second radio base station corresponding to resident cells in which the mobile station is located among the first cells and the second cells;
the communication control method comprising:
in the mobile station, measuring reception characteristics of radio signals sent from the first radio base station and the second radio base stations corresponding to the resident cells and reporting measurement results of the measured reception characteristics to the first radio base station corresponding to the resident cell;
in each of the first radio base stations, deciding a first radio base station and second radio base stations that send radio signals whose reception characteristics exceed a predetermined threshold according to the measurement results reported from the mobile station, to serve as a coordinated-transmission radio base station set for the mobile station, and, when the first radio base station executes radio communication synchronously with a second radio base station connected to the first radio base station, executing transmission of a radio signal to the mobile station located in the first cell of the first radio base station in a first period, and stopping the transmission of the radio signal to the mobile station in a second period;
in each of the second radio base stations, when the second radio base station executes radio communication synchronously with a first radio base station to which the second radio base station connects, executing transmission of a radio signal to the mobile station located in the second cell of the second radio base station in both the first period and the second period for the first radio base station to which the second radio base station connects;
in the first period for the first radio base station, the first radio base station included in the coordinated-transmission radio base station set and the second radio base stations included in the coordinated-transmission radio base station set coordinating with each other to send radio signals to the mobile terminal corresponding to the coordinated-transmission radio base station set; and
in the second period for the first radio base station, the second radio base stations included in the coordinated-transmission radio base station set coordinating with each other to send radio signals to the mobile terminal corresponding to the coordinated-transmission radio base station set.
